(19) United States
(12) Patent Application Publication
(10) Pub. No.: US 2011/0153108 A1
(43) Pub. Date: Jun. 23, 2011

(54) METHOD AND DEVICE FOR REMOTE POWER MANAGEMENT

(75) Inventors: Byung-Sik YOON, Daejeon (KR); Sook-Jin LEE, Daejeon (KR); Song-In CHOI, Daejeon (KR); Jee-Hwan AHN, Daejeon (KR)

(73) Assignee: Electronics and Telecommunications Research Institute, Daejeon (KR)

(21) Appl. No.: 12/971,182

(22) Filed: Dec. 17, 2010

(30) Foreign Application Priority Data
Dec. 18, 2009 (KR) 10-2009-0127063
Jul. 2, 2010 (KR) 10-2010-0063803

(51) Int. Cl. G06F 1/26; G06Q 30/00; G06Q 50/00

(52) U.S. Cl. 700/295; 705/412

(57) ABSTRACT

Provided is a method for remote power management capable of remotely controlling power consumption. The method for remote power management includes: allowing a power management device to generate power information on the basis of power consumption information collected from at least one electronic apparatus and transmit the generated power information to a user terminal through a wireless communication network; and to control an operation of the at least one electronic apparatus in accordance with a control command transmitted in response to the power information from the user terminal through the wireless communication network.

### CROSS REFERENCE TO RELATED APPLICATIONS

This application claims priority to Korean Patent Application Nos. 10-2009-0127063 and 10-2010-0063803 filed on Dec. 18, 2009 and Jul. 2, 2010, respectively, the entire contents of which are herein incorporated by reference.

### BACKGROUND OF THE INVENTION

1. Field of the Invention

The present invention relates to a remote power management technology, and more particularly, to a method and a device for remote power management capable of remotely controlling and managing power consumption by using a portable terminal which a user carries in a smart grid environment.

2. Description of the Related Art

In recent years, various researches have been performed, which can efficiently use and save energy by utilizing a communication network in order to solve an environmental problem caused due to a global warming and reduce carbon emission.

Among them, a technology for a power supplier and a consumer to optimize energy consumption efficiency by interactively exchanging real-time information by grafting information technology (IT) to the existing power network has been developed.

The technology is to maximize energy utilization by connecting a power transmission/distribution facility and a power consumer with a power plant by using a communication network and harmoniously interacting the generation and consumption of energy by using interactively shared information.

That is, the power supplier determines the energy consumed by the power consumer in real time by using the communication network and controls an energy using time and energy usage at minimum cost.

However, in the prior art, the power supplier controls the usage of energy consumed by the power consumer, thus, it is difficult to control energy usage depending on power consumer, that is, user's intention.

### SUMMARY OF THE INVENTION

The preset invention has been made in an effort to provide a method and a device for remote power management capable of remotely controlling power consumption depending on user's intention by using a user terminal which a user can carry.

An exemplary embodiment of the present invention provides a method for remote power management that includes: generating power information on the basis of power consumption information collected from at least one electronic apparatus; transmitting the generated power information to a user terminal through a wireless communication network; and controlling an operation of the at least one electronic apparatus in accordance with a control command transmitted in response to the power information from the user terminal through the wireless communication network.

The steps of the method for remote power management above may be performed by a power management device.

Another exemplary embodiment of the present invention provides a method for remote power management that includes: receiving power information on at least one electronic apparatus transmitted from a power management device through a wireless communication network; generating a control command for controlling an operation of the at least one electronic apparatus in response to the received power information; and outputting the generated control command to the power management device through the wireless communication network.

The steps of the method for remote power management above may be performed by a user terminal.

Yet another exemplary embodiment of the present invention provides a device for remote power management that includes: a measurement unit collecting power consumption information from at least one electronic apparatus, and generating and outputting power information on the basis of the collected information; a communication unit transmitting the power information to a user terminal through a wireless communication network and receiving a control command transmitted from the user terminal in response to the power information; and a control unit controlling an operation of the at least one electronic apparatus in accordance with the received control command.

According to a method and a device for remote power management of exemplary embodiments of the present invention, a user can aim at efficient power consumption of a consumer in a predetermined time or space by remotely managing the power consumption of the consumer with a mobile terminal which the user always carries, and the like.

Further, the remote power management device performs wireless communication using a user's mobile terminal and a short-range communication network of a home automation network when the user is positioned in the consumer so as to save a wireless communication fee which is comparatively expensive.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram of a power management system according to an exemplary embodiment of the present invention;

FIG. 2 is a schematic diagram of the power management device shown in FIG. 1;

FIG. 3 is a flowchart of a power management operation of the power management system of FIG. 1;

FIG. 4 is a flowchart of a power control operation of a power management device according to an exemplary embodiment of the present invention; and

FIG. 5 is a flowchart of a power control operation of a power management device according to another exemplary embodiment of the present invention.

### DETAILED DESCRIPTION OF THE PREFERRED EMBODIMENTS

The accompanying drawings illustrating exemplary embodiments of the present invention and contents described in the accompanying drawings should be referenced in order to fully appreciate operational advantages of the present invention and objects achieved by the exemplary embodiments of the present invention.

Hereinafter, the present invention will be described in detail by describing exemplary embodiments of the present invention with reference to the accompanying drawings. Like elements refer to like reference numerals shown in the drawings.

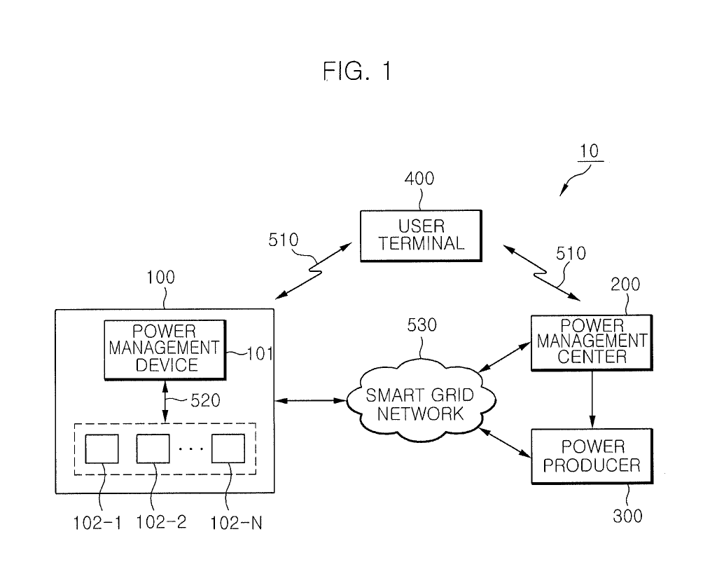

FIG. 1 is a schematic diagram of a power management system according to an exemplary embodiment of the present invention.

Referring to FIG. 1, the power management system 10 may include a consumer 100, a power management center 200, and a power producer 300. The consumer 100, the power management center 200, and the power producer 300 may be connected with each other through a power network 530, i.e., a smart grid network.

The power management system 10 may further include a user terminal 400 that allows a user to manage the power consumption of the consumer 100.

The user terminal 400 may be a mobile terminal which is wirelessly communicable, such as a cellular phone, a smart phone, a PDA, a PMP, or the like which is a mobile terminal which can be carried by the user.

The user terminal 400 may be connected with a power management device 101 of the consumer 100 or the power management center 200 through a first communication network 510, i.e., a mobile communication network or a short-range/long-range wireless communication network.

Herein, the mobile communication network may be a 2G or 3G mobile communication network and the short-range/long-range wireless communication network may be wireless Internet communication networks such as WiBro, WiFi, WiMax, Ethernet, and the like or wireless communication networks such as ZigBee, Bluetooth, Femto Cell, and the like.

The consumer 100 may be power consumers such as a house, an apartment, a building, and the like, and may include a plurality of electronic apparatuses 102_1, 102_2, . . . , 102_N) and the power management device 101 capable of managing the power consumption of the electronic apparatuses.

The plurality of electronic apparatuses 102_1, 102_2, . . . , 102_N in the consumer 100 as apparatuses that consume assigned power transmitted to the consumer 100 from the power producer 300 through a power network 530 may include, for example, a TV, a refrigerator, a computer, and the like.

The plurality of electronic apparatuses 102_1, 102_2, . . . , 102_N may be connected with the power management device 101 through a second communication network 520, i.e., the wireless communication network or ZigBee, Bluetooth, Femto Cell, and the like or a power line communication network (PLC).

The power management device 101 may collect information transmitted from each of the plurality of electronic apparatuses 102_1, 102_2, . . . , 102_N connected through the second communication network 520 and manage the information as power information.

Further, the power management device 101 may control an operation of each of the plurality of connected electronic apparatuses 102_1, 102_2, 102_N in accordance with a control command transmitted from the user terminal 400 through the first communication network 510.

The power management device 101 may constitute a home automation network (HAN) of the consumer 100 together with the plurality of connected electronic apparatuses 102_1, 102_2, . . . , 102_N.

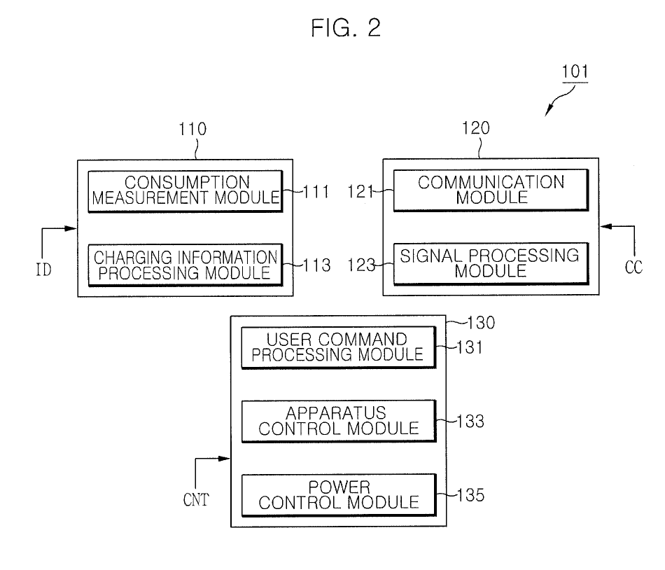

FIG. 2 is a schematic diagram of the power management device shown in FIG. 1.

Referring to FIGS. 1 and 2, the power management device 101 may include a measurement unit 110, a communication unit 120, and a control unit 130.

The measurement unit 110 collects information transmitted from each of the plurality of electronic apparatuses 102_1, 102_2, . . . , 102_N through the second communication network 520 to generate power information for each electronic apparatus.

The generated power information may be outputted to the user terminal 400 or the power management center 200 through the communication unit 120 to be described below.

Herein, the power information may include information on power consumption of each of the plurality of electronic apparatuses 102_1, 102_2, . . . , 102_N and the resulting consumption fee, that is, charging information.

The measurement 110 may include a consumption measurement module 111 and a charging information processing module 113.

The consumption measurement module 111 measures power consumption consumed by each of the plurality of electronic apparatuses 102_1, 102_2, . . . , 102_N based on the information transmitted from each of the plurality of electronic apparatuses 102_1, 102_2, . . . , 102_N and may output the resulting power consumption information for each electronic apparatus.

The charging information processing module 113 may calculate or receive a charging fee for the measured power consumption and output the resulting charging information for each electronic apparatus.

For example, the charging information processing module 113 may calculate the charging fee for each electronic apparatus in accordance with a predetermined reference on the basis of the measured power consumption and output the charging information for each electronic apparatus on the basis of the calculated charging fee.

Further, the charging information processing module 113 may transmit the measured power consumption to the power management center 200 through the power network 530 and output the charging information on the basis of the charging fee for each electronic apparatus calculated and transmitted from the power management center 200.

The measurement unit 110 may generate power information including the power consumption information outputted from the consumption measurement module 111 and the charging information outputted from the charging information processing module 113.

Further, the measurement unit 110 may manage the power information for each electronic apparatus by combining unique information assigned to each of the plurality of electronic apparatuses 102_1, 102_2, . . . , 102_N, that is, ID information ID of each electronic apparatus with the generated power information.

The communication unit 120 may transmit the power information outputted from the measurement unit 110 to the user terminal 400 through the first communication network 510 or provides a control command CNT transmitted from the user terminal through the first communication network 510 to the control unit 130.

Further, the communication unit 120 may receive the information transmitted from the plurality of electronic apparatuses 102_1, 102_2, . . . , 102_N through the second communication network 520 and transmit the received information to the measurement unit 110.

The communication unit 120 may communicate with an external apparatus, i.e., the user terminal 400 or the power management center 200 by using various communication protocols in accordance with a communication control signal CC and may include a communication module 121 and a signal processing module 123.

The communication module 121 may perform data communication with external apparatuses by using various communication protocols in accordance with the communication control signal CC.

The signal processing module 123 may perform signal processing for data transmitted to the outside or data received from the outside by using various communication protocols in accordance with the communication control signal CC.

For example, when the power management device 101 attempts to collect information from the plurality of electronic apparatuses 102_1, 102_2, 102_N, the communication unit 120 may communication with the plurality of electronic apparatuses 102_1, 102_2, . . . , 102_N through the second communication network 520 by using the short-range wire/wireless communication protocols, i.e., communication protocols such as ZigBee, Bluetooth, Femto Cell, and the like in accordance with the communication control signal CC. The communication unit 120 may transmit the information transmitted from the plurality of electronic apparatuses 102_1, 102_2, 102_N to the measurement unit 110.

Further, when the power management device 101 attempts to transmit the generated power information to the user terminal 400, the communication unit 120 may communicate with the user terminal 400 through the first communication network 510 by using the mobile communication protocol or the wireless communication protocol in accordance with the communication control signal CC.

Herein, when the user terminal 400 is positioned inside of the consumer 100, the communication unit 120 may communicate with the user terminal 400 by using the communication protocols such as ZigBee, Bluetooth, Femto Cell, and the like.

Further, when the user terminal 400 is positioned outside of the consumer 100, the communication unit 120 may communicate with the user terminal 400 by using the communication protocols such as 2G, 3G, and the like or the communication protocols such as WiBro, WiFi, WiMax, and the like.

In addition, even when the communication unit 120 receives a control command CNT corresponding to the power information from the user terminal 400, the communication unit 120 may use the same communication protocols as those at the time of transmitting the power information.

Besides, when the power management device 101 attempts to transmit the generated power information to the power management center 200 or transmit a power request signal to the power management center 200, the communication unit 120 may communication with the power management center 200 by using a power network communication protocol, i.e., a smart grid power network communication protocol through the power network 530.

That is, the power management device 101 according to the exemplary embodiment of the present invention may use an appropriate communication protocol depending on whether or not the power management device 101 communicates with any apparatus, i.e., the user terminal 400, the power management center 200, or any one selected from the plurality of electronic apparatuses 102_1, 102_2, . . . , 102_N in the consumer 100.

The control unit 130 may control operations of the plurality of electronic apparatuses 102_1, 102_2, . . . , 102_N on the basis of the control command CNT transmitted from the user terminal 400.

The control unit 130 may include a user command processing module 131, an apparatus control module 133, and a power control module 135.

The user command processing module 131 may determine the control command CNT which a user transmits to the power management device 101 by using the user terminal 400 and operate the apparatus control module 133 or the power control module 135 on the basis of the determination result.

For example, when the user attempts to control an operation of a predetermined electronic apparatus among the plurality of electronic apparatuses 102_1, 102_2, . . . , 102_N of the consumer 100 by using the user terminal 400 in accordance with a predetermined condition, the user command processing module 131 may determine a set condition of the control command CNT transmitted from the user terminal 400 and operate the apparatus control module 133 or the power control module 135 on the basis of the determination result.

The apparatus control module 133 may control an operation of a predetermined electronic apparatus among the plurality of electronic apparatuses 102_1, 102_2, . . . , 102_N on the basis of the determination result of the user command processing module 131.

The power control module 135 may request additional power to the power management center 200 on the basis of the determination result of the user command processing module 131.

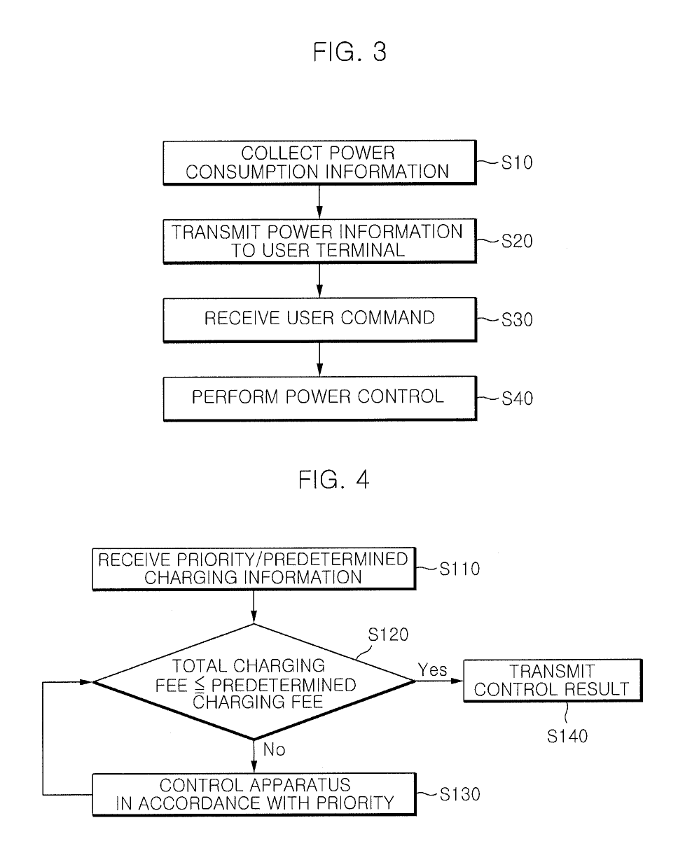

The above-mentioned operation of the power management device 101 will be described in detail with reference to FIGS. 3 to 5 to be described below.

Referring back to FIG. 1, the power management center 200 may be connected with the consumer 100 through the power network 530 and connected with the user terminal 400 through the first communication network 510.

The power management center 200 may monitor the consumer 100 on the basis of the power information transmitted from the power management device 101 of the consumer 100. Further, the power management center 200 may calculate the consumption fee on the basis of the power information.

Further, the power management center 200 may transmit the power information on the consumer 100 to the user terminal 400 through the first communication network 510 in accordance with a request from the user terminal 400.

The power management center 200 may control the power producer 300 in accordance with a request for additional power from the power management device 101 of the consumer 100 and the power producer 300 may supply the additional power to the consumer 100 in accordance with a control by the power management center 200.

The power producer 300 may be a power production facility in an area managed by the power management center 200, i.e., a power plant and may supply power to the consumer 100 through the power network 530 in accordance with the control by the power management center 200.

According to various exemplary embodiments of the present invention, the power producer 300 may include a power production facility installed in a predetermined consumer, i.e., a generation facility of sunlight, geothermal heat, wind power, or the like. In this case, the power management center 200 may supply power to a consumer that requests additional power from a predetermined consumer by controlling a power management device of the predetermined consumer.

FIG. 3 is a flowchart of a power management operation of the power management system of FIG. 1.

Referring to FIGS. 1 to 3, the power management device 101 of the consumer 100 may collect power consumption information from each of the plurality of electronic apparatuses 102_1, 102_2, . . . , 102_N(S10).

For example, the measurement unit 110 of the power management device 101 may measure the power consumption information for each electronic apparatus from the power consumption information collected from each of the plurality of electronic apparatuses 102_1, 102_2, . . . , 102_N and may deduce the charging information for each electronic apparatus on the basis of the measured power consumption information for each electronic apparatus.

Further, the measurement unit 110 may generate power information by combining ID information ID of each of the plurality of electronic apparatuses 102_1, 102_2, . . . , 102_N with the power consumption information and charging information for each electronic apparatus.

The generated power information may be transmitted to the user terminal 400 through the first communication network 510 (S20).

For example, the power management device 101 may transmit the power information by using the short-range wireless communication protocol when the user terminal 400 is positioned inside of the consumer 100. Further, the power management device 101 may transmit the power information by using the mobile communication protocol or the long-range wireless communication protocol when the user terminal 400 is positioned outside of the consumer 100.

In addition, according to various exemplary embodiments of the present invention, the user may access the power management center 200 through the first communication network 510 by using the user terminal 400 and may receive power information on the plurality of electronic apparatuses 102_1, 102_2, . . . , 102_N of the consumer 100 transmitted from the power management center 200.

The user may generate the control command CNT on the basis of the power information received by the user terminal 400, that is, the power information on each of the plurality of electronic apparatuses 102_1, 102_2, . . . , 102_N of the consumer 100, and may transmit the generated control command CNT to the power management device 101 through the first communication network 510 (S30).

The power management device 101 may determine the control command CNT transmitted from the user terminal 400 and may perform power control of controlling the operations of the plurality of electronic apparatuses 102_1, 102_2, . . . , 102_N of the consumer 100 in accordance with the determination result (S40).

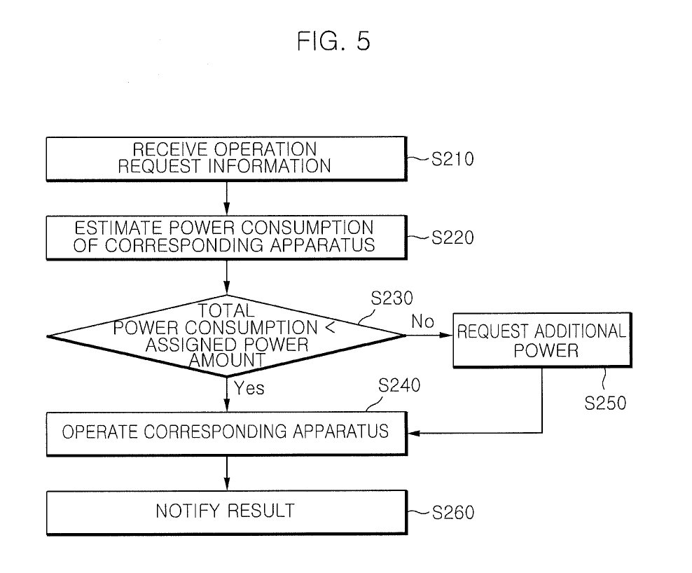

FIG. 4 is a flowchart of a power control operation of a power management device according to an exemplary embodiment of the present invention and FIG. 5 is a flowchart of a power control operation of a power management device according to another exemplary embodiment of the present invention.

Referring to FIGS. 1 to 4, the user terminal 400 may receive the power information on the plurality of electronic apparatuses 102_1, 102_2, . . . , 102_N transmitted from the power management device 101 through the first communication network 510.

Subsequently, the user may generate a control command CNT for stopping an operation of a predetermined electronic apparatus among the plurality of electronic apparatuses 102_1, 102_2, . . . , 102_N.

The user may set priorities of the plurality of electronic apparatuses 102_1, 102_2, . . . , 102_N and a charging fee of the consumer 100 on the basis of the power information received by using the user terminal 400, and may generate the control command CNT on the basis of the set priority information and the charging fee information. The generated control command CNT may be transmitted to the power management device 101 through the first communication network 510 (S110).

Further, the user arbitrarily selects at least one electronic apparatus which the user attempts to stop on the basis of the received power information and may generate information on at least one selected electronic apparatus, i.e., ID information of the corresponding information by using the control command CNT together with an operation stop command.

The power management device 101 may determine the received control command CNT and perform a power control operation on the basis of the determination result.

For example, the power management device 101 may compare a total charging fee of the consumer resulting from the power consumptions of the plurality of electronic apparatuses 102_1, 102_2, . . . , 102_N measured by the measurement unit 110 with a predetermined charging fee included in the received control command CNT (S120).

When the total charging fee of the consumer is smaller than or equal to the predetermined charging fee on the basis of the comparison result, the power management device 101 may determine that the power management device 101 does not need to perform the power control and notify the determination result to the user terminal 400 (S140).

However, when the total charging fee of the consumer is larger than the predetermined charging fee on the basis of the comparison result, the power management device 101 may perform the power control operations of the plurality of electronic apparatuses 102_1, 102_2, . . . , 102_N in accordance with the priority information included in the control command CNT (S130).

For example, the control unit 130 of the power management device 101 may stop one electronic apparatus having the lowest priority among the plurality of electronic apparatuses 102_1, 102_2, . . . , 102_N in accordance with the priority information of the control command CNT.

Subsequently, the measurement unit 110 may calculate a total charging fee of the consumer for power consumption of the rest of the electronic apparatuses other than one electronic apparatus that stops again, and the control unit 130 may repetitively compare the predetermined charging fee with the recalculated total charging fee of the consumer (S120).

Herein, the measurement unit 110 and the control unit 130 of the power management device 101 stop the operations of the plurality of electronic apparatuses 102_1, 102_2, . . . , 102_N in sequence in accordance with the priority information included in the control command CNT until the total charging fee of the consumer by the plurality of electronic apparatuses 102_1, 102_2, . . . , 102_N is smaller than or equal to the predetermined charging fee and may repetitively recalculate and compare the resulting total charging fee of the consumer.

Referring to FIGS. 1 to 3 and 5, the user terminal 400 may receive the power information on each of the plurality of electronic apparatuses 102_1, 102_2, . . . , 102_N transmitted from the power management device 101 through the first communication network 510.

Subsequently, the user may generate a control command CNT for starting an operation of a predetermined electronic apparatus among the plurality of electronic apparatuses 102_1, 102_2, . . . , 102_N.

For example, the user may generate operation request information for starting an operation of one electronic apparatus which does not operate at present among the plurality of electronic apparatuses 102_1, 102_2, . . . , 102_N in the consumer 100 on the basis of the power information received by using the user terminal 400 and generate a control command CNT including the operation request information and ID information of the corresponding apparatus. Further, the control command CNT may further include information on an operation start time of the corresponding apparatus.

The generated control command CNT may be transmitted to the power management device 101 through the first communication network 510 (S210).

The power management device 101 may determine the received control command CNT and perform a power control operation on the basis of the determination result.

For example, the power management device 101 may estimate power consumption of the corresponding apparatus on the basis of the received control command CNT (S220).

In addition, the power management device 101 may calculate total power consumption of the consumer including the estimated power consumption of the corresponding apparatus.

Herein, the power management device 101 may estimate the power consumption of the corresponding apparatus which is requested to operate on the basis of the existing stored power consumption of each of the plurality of electronic apparatuses 102_1, 102_2, . . . , 102_N.

Subsequently, the power management device 101 may compare assigned power amount assigned to the consumer 100 with the calculated total power consumption of the consumer (S230).

When the total power consumption of the consumer is smaller than the assigned power amount on the basis of the comparison result, the control unit 130 of the power management device 101 may operate the corresponding electronic apparatus which is requested to operate (S240).

In this case, the control unit 130 may operate the corresponding apparatus at a requested operation start time on the basis of information on the operation start time of the corresponding apparatus included in the control command CNT transmitted from the user terminal 400.

Subsequently, the power management device 101 may notify the operation result of the corresponding apparatus to the user terminal 400 (S260).

However, when the total power consumption of the consumer is larger than or equal to the assigned power amount on the basis of the comparison result, the control unit 130 of the power management device 101 may transmit a request signal of requesting additional power to the power management center 200 connected through the power network 530 (S250).

The power management center 200 may control the power producer 300 in accordance with the request signal transmitted from the power management device 101 and the power producer 300 may supply the requested additional power to the consumer 100 through the power network 530.

When the supplying of the additional power from the power producer 300 is completed, the control unit 130 of the power management device 101 may start the operation of the corresponding apparatus which is requested to operate (S240) and notify the operation start to the user terminal 400 (S260).

Although the exemplary embodiments of the present invention have been shown and described, it will be appreciated by those skilled in the art that substitutions, modifications and changes may be made in these exemplary embodiments without departing from the principles and spirit of the general inventive concept, the scope of which is defined in the appended claims and their equivalents. Accordingly, the actual technical protection scope of the present invention must be determined by the spirit of the appended claims.

What is claimed is:

1. A method for remote power management, comprising:
generating power information on the basis of power consumption information collected from at least one electronic apparatus;
transmitting the power information to a user terminal through a wireless communication network; and
controlling an operation of the at least one electronic apparatus in accordance with a control command transmitted in response to the power information from the user terminal through the wireless communication network.

2. The method of claim 1, wherein the transmitting the power information to the user terminal through the wireless communication network includes:
measuring power consumption for each electronic apparatus on the basis of the collected power consumption information; and
calculating charging information for each electronic apparatus on the basis of the power consumption,
wherein the power information includes the power consumption and the charging information for each electronic apparatus.

3. The method of claim 2, wherein the power information further includes ID information of each electronic apparatus.

4. The method of claim 2, wherein the calculating the charging information for each electronic apparatus transmits the measured power consumption through a power network to a power management center, and receives the charging information for each electronic apparatus transmitted in response to the power consumption from the power management center.

5. The method of claim 1, wherein the controlling the operation of the at least one electronic apparatus includes:
receiving the control command, including priority information of the at least one electronic apparatus and a predetermined charging fee, transmitted from the user terminal;
comparing a total charging fee for the power consumption of the at least one electronic apparatus with the predetermined charging fee; and
sequentially stopping the operation of the at least one electronic apparatus in accordance with the priority information on the basis of the comparison result.

6. The method of claim 5, wherein the sequential stopping the operation of the at least one electronic apparatus stops the operation of the at least one electronic apparatus sequentially from the electronic apparatus corresponding to the lowest prioirty information when the total charging fee is larger than the predetermined charging fee.

7. The method of claim 1, wherein the controlling the operation of the at least one electronic apparatus includes:
receiving the control command including operation request information of a predetermined electronic apparatus transmitted from the user terminal;
estimating power consumption of the predetermined electronic apparatus in accordance with the operation request information and, calculating total power consumption including the estimated power consumption;
comparing assigned power amount with the total power consumption; and
starting the operation of the predetermined electronic apparatus on the basis of the comparison result.

8. The method of claim 7, wherein the starting the operation of the predetermined electronic apparatus starts the operation of the predetermined electronic apparatus when the total power consumption is smaller than the assigned power amount.

9. The method of claim 7, wherein the starting the operation of the predetermined electronic apparatus includes:
requesting additional power to the power management center through the power network when the total power consumption is larger than or equal to the assigned power amount; and
starting the operation of the predetermined electronic apparatus after the additional power is supplied.

10. The method of claim 1, wherein the wireless communication network is one of a 2G mobile communication network, 3G mobile communication network, Wibro wireless Internet network, WiFi wireless internet network, WiMax wireless internet network, Zigbee communication network, Bluetooth communication network and Femto Cell communication network.

11. A method for remote power management, comprising:
receiving power information on at least one electronic apparatus transmitted from a power management device through a wireless communication network;
generating a control command for controlling an operation of the at least one electronic apparatus in response to the received power information; and
outputting the generated control command to the power management device through the wireless communication network.

12. The method of claim 11, wherein the control command includes priority information and a predetermined charging fee in order to control the stopping of the operation of the at least one electronic apparatus.

13. The method of claim 11, wherein the control command includes operation request information in order to control the starting of an operation of a predetermined electronic apparatus.

14. The method of claim 11, wherein the wireless communication network is one of a 2G mobile communication network, 3G mobile communication network, Wibro wireless Internet network, WiFi wireless internet network, WiMax wireless internet network ZigBee communication network, Bluetooth communication network, Femto Cell communication network.

15. A device for power management, comprising:
a measurement unit collecting power consumption information from at least one electronic apparatus, and generating power information on the basis of the collected information;
a communication unit transmitting the power information to a user terminal through a wireless communication network and receiving a control command transmitted from the user terminal in response to the power information; and
a control unit controlling an operation of the at least one electronic apparatus in accordance with the received control command.

16. The device of claim 15, wherein the measurement unit measures power consumption for each electronic apparatus on the basis of the collected power consumption information and the communication unit receives charging information for each electronic apparatus transmitted from the power management center in response to the power consumption by transmitting the measured power consumption to a power management center through a power network.

17. The device of claim 16, wherein the power network is a smart grid power network.

18. The device of claim 15, wherein the user terminal is a mobile terminal apparatus.

19. The device of claim 15, wherein the wireless communication network is one of a 2G mobile communication network, 3G mobile communication network, Wibro wireless Internet network, WiFi wireless internet network, WiMax wireless internet network, Zigbee communication network, Bluetooth communication network and Femto Cell communication network.
